(19) United States
(12) Patent Application Publication
(10) Pub. No.: US 2025/0209659 A1
(43) Pub. Date: Jun. 26, 2025

(54) INPUT ASSISTANCE APPARATUS, INPUT ASSISTANCE METHOD, AND NON-TRANSITORY COMPUTER READABLE MEDIUM

(71) Applicant: NEC Corporation, Minato-ku, Tokyo (JP)

(72) Inventor: Akira TSUCHIYA, Tokyo (JP)

(73) Assignee: NEC Corporation, Minato-ku, Tokyo (JP)

(21) Appl. No.: 18/846,311

(22) PCT Filed: Mar. 30, 2022
(86) PCT No.: PCT/JP2022/016149

§ 371 Date: Sep. 12, 2024

(51) Int. Cl. G06T 7/73

(52) U.S. Cl. CPC G06T 7/73; G06T 2200/24; G06T 2207/20081; G06T 2207/20101; G06T 2207/30201

(57) ABSTRACT

Provided are an input assistance apparatus, an input assistance method, and a program capable of more appropriately determining a position of a feature point. An input assistance apparatus (1) includes an estimation unit (2) that estimates a position of a feature point of an input image, and an input assistance unit (3) that assists a user's input for designating a position of a feature point of the input image on the basis of a position estimated by the estimation means and a position designated by the input.

### TECHNICAL FIELD

The present disclosure relates to an input assistance apparatus, an input assistance method, and a program.

### BACKGROUND ART

As a preparation for performing information processing using an image, there is a case where a user confirms the image and the work of designating a position of a feature point in the image by the user is performed. For example, in order to create a database of a collation system that specifies a person using a face image, a user who is a database creator may specify the position of a feature point for each of face images of a plurality of known persons. In addition, for example, in order to specify a person using a face image by the collation system, a user who is a person in charge of search sometimes inputs a position of a feature point of a face of a person to be specified to the collation system. In addition, for example, in order to prepare the training data of the machine learning model, the user who is the training data creator may designate the position of the feature point of the image. In this way, for an arbitrary purpose, the work of designating the position of the feature point in the image by the user may be performed.

Meanwhile, as a related technique, a contour detection apparatus described in Patent Literature 1 is known. According to this contour detection apparatus, a feature point having low reliability as a contour is designated with respect to the automatic detection result of the feature point of the contour of the nail from the image.

### CITATION LIST

### Patent Literature

Patent Literature 1: Japanese Unexamined Patent Application Publication No. 2019-057111

### SUMMARY OF INVENTION

### Technical Problem

As described in Patent Literature 1, there is a possibility that the estimation result by the apparatus is wrong. On the other hand, the determination by the user (human) may be wrong. Therefore, it is possible to more appropriately determine the position of the feature point by focusing on the difference between the estimation result of the apparatus and the determination of the user instead of focusing only on the error of the estimation result of the apparatus. However, in the technique described in Patent Literature 1, it is possible to easily designate an error in the automatic detection result of the feature point, but processing focusing on a difference between the position estimated by the apparatus and the position designated by the user for the feature point is not performed.

Therefore, one of the objects to be achieved by the example embodiments disclosed in this specification is to provide an input assistance apparatus, an input assistance method, and a program capable of more appropriately determining the position of a feature point.

### Solution to Problem

An input assistance apparatus according to a first aspect of the present disclosure includes:
an estimation means for estimating a position of a feature point of an input image; and
an input assistance means for assisting a user's input for designating a position of a feature point of the input image on a basis of a position estimated by the estimation means and a position designated by the input.

An input assistance method according to a second aspect of the present disclosure includes:
estimating a position of a feature point of an input image; and
assisting a user's input for designating a position of a feature point of the input image on a basis of an estimated position and a position designated by the input.

A program according to a third aspect of the present disclosure causes a computer to execute:
estimating a position of a feature point of an input image; and
assisting a user's input for designating a position of a feature point of the input image on a basis of a position estimated by the estimating and a position designated by the input.

### BRIEF DESCRIPTION OF DRAWINGS

FIG. 1 is a block diagram illustrating an example of a configuration of an input assistance apparatus according to an outline of an example embodiment.

FIG. 2 is a schematic diagram illustrating an example of an image of an eye.

FIG. 3 is a block diagram illustrating an example of a functional configuration of an input assistance apparatus according to a first example embodiment.

FIG. 4 is a schematic diagram illustrating an example in which a user interface unit displays a feature point at an estimated position on an input image.

FIG. 5 is a block diagram illustrating an example of a hardware configuration of the input assistance apparatus according to the first example embodiment.

FIG. 6 is a flowchart illustrating an example of an operation of the input assistance apparatus according to the first example embodiment.

FIG. 7 is a schematic diagram for explaining input in an incorrect order.

FIG. 8 is a block diagram illustrating an example of a functional configuration of an input assistance apparatus according to a second example embodiment.

FIG. 9 is a flowchart illustrating an example of an operation of the input assistance apparatus according to the second example embodiment.

### EXAMPLE EMBODIMENT

### Outline of Example Embodiments

First, an outline of an example embodiment will be described.

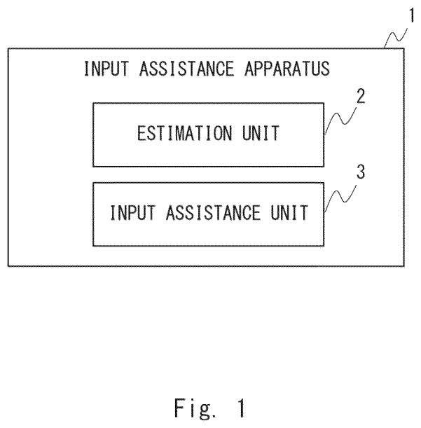

FIG. 1 is a block diagram illustrating an example of a configuration of an input assistance apparatus 1 according to an outline of the example embodiment. As illustrated in FIG. 1, the input assistance apparatus 1 includes an estimation unit 2 and an input assistance unit 3. The input assistance apparatus 1 is an apparatus used for a user to designate a position of a feature point with respect to an input image that is an image input to the input assistance apparatus 1. Note that the input image is, for example, a face image showing a human face, and the feature point is, for example, a feature point of the face, but the input image and the feature point are not limited thereto. For example, an arbitrary target object such as an animal, an automobile, or a structure may be displayed in the input image. In addition, the type of the feature point is not limited as long as the feature point is defined in advance for each target object. Hereinafter, each component of the input assistance apparatus 1 will be described.

The estimation unit 2 estimates the position of the feature point of the input image. For example, the estimation unit 2 may perform estimation using a machine learning model learned in advance. Here, the machine learning model is learned in advance using a set of an image and a position of a feature point of a target object appearing in the image as training data. In the training data, the position of the feature point is designated in advance by, for example, a skilled worker of the work of designating the position of the feature point. In other words, in the training data, the position of the feature point is designated to a correct position matching the definition of the feature point.

The input assistance unit 3 assists the user's input for designating the position of the feature point of the input image on the basis of the position estimated by the estimation unit 2. Here, assisting the input for designating the position of the feature point means, for example, performing processing of presenting predetermined information to the user when the user designates the position of the feature point, such as display of an estimated position, output of a warning, and display of an order of designation of the position. In particular, the input assistance unit 3 assists the user's input on the basis of the position estimated by the estimation means and the position designated by the input. For example, the input assistance unit 3 may assist the user's input by outputting a warning based on a difference between the position estimated by the estimation unit 2 and the position designated by the user's input.

According to the input assistance apparatus 1, the estimation result and the input result of the estimation unit 2 are used to assist the user's input. Therefore, according to the input assistance apparatus 1, the position of the feature point can be determined after the estimation by the apparatus and the determination by the user are complemented with each other. Therefore, according to the input assistance apparatus 1, the position of the feature point can be more appropriately determined as compared with a case where the present apparatus is not used.

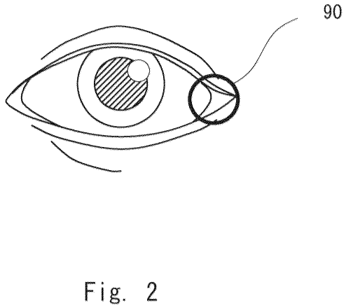

In general, since what portion of the target object is set as the feature point is defined in advance, the user designates a position matching this definition as the position of the feature point with respect to the input image. However, not all users who know the definition of the feature point, that is, the reference to be satisfied as the feature point can plot the feature point at the same position. The position of the feature point designated by the user can vary depending on experience of the user, and can vary depending on unclear definition of the feature point. In particular, a feature point of a subject having an individual difference such as a human face is not strictly defined for each individual, but is generally defined ignoring the individual difference, so that the definition of the feature point may be unclear for each individual. Therefore, it is not easy for the user to plot the feature point at an appropriate position. For example, it is assumed that designation of a point at the outer corner of the eye 90 (see FIG. 2) is defined in advance as the feature point of the eye. However, since each person has different shapes, sizes, and the like of the eyes, it is difficult to accurately define the positions of the feature points of the outer corners of the eyes common to all persons in advance. For this reason, it is particularly difficult for a less experienced user to designate the position of the feature point at an appropriate position only from the definition of the feature point. Therefore, in a case where a less experienced user performs the work, the position of the feature point of the outer corner of the eye may vary.

On the other hand, in a case where the user uses the input assistance apparatus 1, the user can receive input assistance on the basis of the position of the feature point estimated by the estimation unit 2. For example, if estimation is performed using a model learned using training data in which an appropriate position of the feature point of the outer corner of the eye is designated, an appropriate position of the feature point of the outer corner of the eye is estimated for most input images. This estimation result can prevent an error in designation of the feature of the user. Further, with such an estimation result, the user can understand an appropriate position that is difficult to understand from the definition of the general-purpose feature point. Then, even if an inappropriate position is estimated when a peculiar face image or the like is input to the estimation unit 2 (for example, a machine learning model), the user who has understood an appropriate position can designate an appropriate position. That is, even a beginner in the input work of designating the position of the feature point can designate the position of the feature point in the same manner as a skilled person who is familiar with the reference of the position of the feature point.

Note that, in the above description, the input assistance apparatus 1 having the configuration illustrated in FIG. 1 has been described, but an aspect for obtaining the above effect is not limited to the apparatus. For example, similar effects can be obtained in an input assistance method including the above-described processing of the input assistance apparatus 1, a program for performing the above-described processing of the input assistance apparatus 1, or a non-transitory computer readable medium storing the program.

Hereinafter, the example embodiment of the present disclosure will be described in detail with reference to the drawings. Note that in the description and drawings to be described below, omission and simplification are made as appropriate, for clarity of description. In each drawing, the similar components are denoted by the same reference signs, and redundant description will be omitted as necessary.

### First Example Embodiment

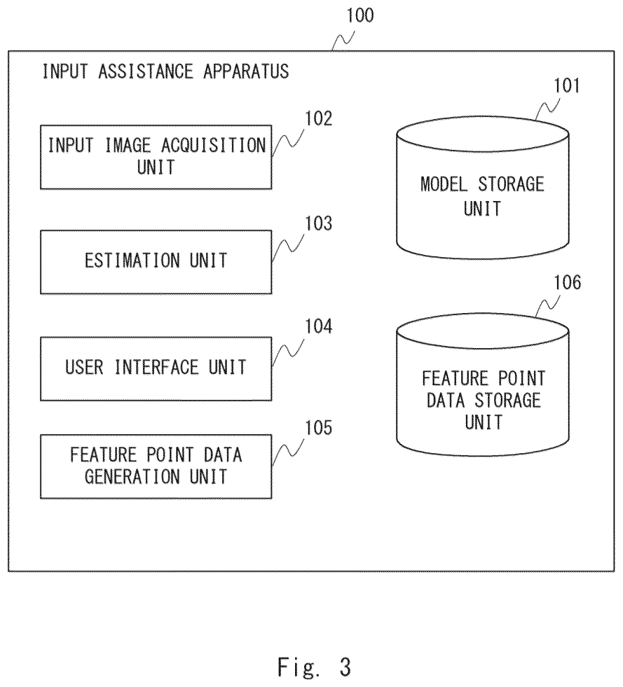

FIG. 3 is a block diagram illustrating an example of a functional configuration of an input assistance apparatus 100 according to a first example embodiment. The input assistance apparatus 100 is an apparatus corresponding to the input assistance apparatus 1 of FIG. 1. Note that, in the present example embodiment, the input assistance apparatus 100 assists input for designating the position of the feature point of the face image as an example, but the input assistance apparatus 100 may assist input for designating the position of the feature point of the target object other than the face. The user performs an input for designating a position of a feature point of a target object (face) using the input assistance apparatus 100. Note that the user is, for example, a beginner who has grasped the definition of the feature point in advance but is not accustomed to the input work. However, the user of the input assistance apparatus 100 is not limited to such a user. The user of the input assistance apparatus 100 may be a skilled person in inputting the positions of the feature points, or may be a person who has not grasped the definition of the feature points in advance.

As illustrated in FIG. 3, the input assistance apparatus 100 includes a model storage unit 101, an input image acquisition unit 102, an estimation unit 103, a user interface unit 104, a feature point data generation unit 105, and a feature point data storage unit 106. These will be described below.

The model storage unit 101 stores a machine learning model for estimating the position of a predetermined feature point of a predetermined target object appearing in an image. In this example embodiment, the predetermined target object is a human face. In addition, the predetermined feature point is nineteen points defined in advance corresponding to a predetermined part of the face. Specifically, these nineteen feature points are three points for each eyebrow, three points for each eye, four points for the nose, and three points for the mouth. Note that the number of feature points is merely an example, and more feature points or fewer feature points may be defined. Of course, an example of which part is used as the feature point is merely shown, and the feature point is not limited to the above. This machine learning model is learned in advance by machine learning such as deep learning using a set of an image and a position of a feature point of a target object appearing in the image as training data. Specifically, the machine learning model stored in the model storage unit 101 is learned in advance using the position of the feature point designated by a skilled worker of the work of designating the position of the feature point as training data. That is, the machine learning model is learned using training data in which a correct position matching the definition of the feature point is indicated as the position of the feature point.

Although the model storage unit 101 is included in the input assistance apparatus 100 in the configuration illustrated in FIG. 3, the model storage unit 101 may be implemented in another apparatus communicably connected to the input assistance apparatus 100 via a network or the like.

The input image acquisition unit 102 acquires an image that is input to the input assistance apparatus 100 and in which the position of the feature point should be designated. That is, the input image acquisition unit 102 acquires an image showing a predetermined target object (human face). Typically, the input image is an image captured by an imaging device such as a camera, but may not necessarily be such an image, and may be an image of a target object represented by computer graphics. The input image acquisition unit 102 may acquire an input image by receiving an input image from another apparatus, or may acquire an input image by reading from a storage device built in the input assistance apparatus 100 or a storage device connected to the input assistance apparatus 100.

The estimation unit 103 corresponds to the estimation unit 2 in FIG. 1. The estimation unit 103 estimates the positions of the feature points of the input image acquired by the input image acquisition unit 102 using the machine learning model stored in the model storage unit 101. Here, the estimation unit 103 estimates the positions of nineteen feature points with respect to the face image.

The user interface unit 104 provides a user interface that accepts, from the user, an input for designating the position of the feature point with respect to the input image acquired by the input image acquisition unit 102, and accepts the input from the user. For example, the user interface unit 104 displays the input image, and displays a UI screen on which a user interface (UI) component for receiving input from the user is arranged on the output device 150 to be described later. That is, the user interface unit 104 provides a graphical user interface (GUI) for receiving input of designation of the position of the feature point from the user. Then, the user interface unit 104 receives designation of the position of the feature point input via the input device 151 described later.

The user interface unit 104 may be referred to as an input assistance unit. The user interface unit 104 assists the user's input for designating the position of the feature point of the input image on the basis of the position estimated by the estimation unit 103. In this example embodiment, specifically, the user interface unit 104 assists the user's input by displaying the position estimated by the estimation unit 103 prior to the user's input of the position of the feature point. More specifically, the user interface unit 104 displays the feature point at the position estimated by the estimation unit 103 on the input image.

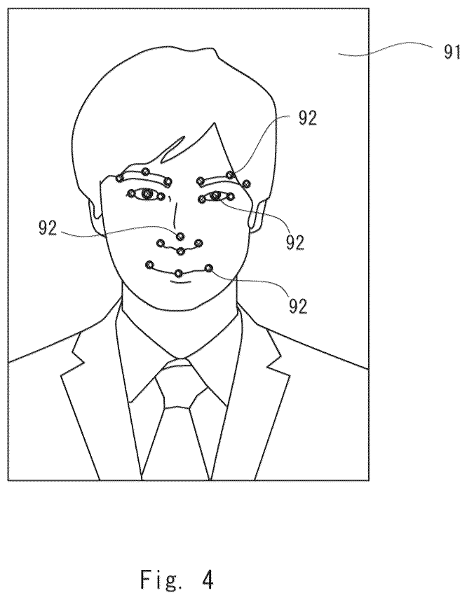

FIG. 4 is a schematic diagram illustrating an example in which the user interface unit 104 displays feature points at estimated positions on an input image 91. As illustrated in FIG. 4, the user interface unit 104 displays nineteen feature points 92 at the positions estimated by the estimation unit 103. In FIG. 4, in order to prevent the drawing from becoming complicated, only some of the nineteen feature points are denoted by reference numerals.

In this case, the user performs an input for designating the position of each feature point while referring to the position of the feature point displayed on the basis of the estimation result. Note that the input for designating the position of each feature point may be an input for correcting the position of the feature point displayed on the basis of the estimation result, or may be an input for accepting the position of the feature point displayed on the basis of the estimation result.

Further, the user interface unit 104 may assist the user's input by outputting a warning on the basis of the magnitude of the deviation between the position designated by the user's input and the position estimated by the estimation unit 103. In this case, the user interface unit 104 outputs a warning, for example, in a case where the magnitude of the deviation between the two exceeds a predetermined threshold. Specifically, for example, the user interface unit 104 outputs a warning for notifying that there is a possibility that the position designated by the user is incorrect. Note that this warning may be displayed on the UI screen or may be output by voice. The user who has received the warning can designate an appropriate position as the position of the feature point by correcting the position of the feature point as necessary. In addition, when the user who has received the warning determines that the estimation result of the estimation unit 103 is incorrect, the user may determine the designated position against the warning.

The feature point data generation unit 105 uses a position designated by the input received from the user, that is, a position determined according to the user's input, as the position of the feature point of the input image, and generates feature point data representing the feature point of the input image for each input image. The feature point data generation unit 105 stores the generated feature point data in the feature point data storage unit 106. Note that the feature point data generation unit 105 may store the input image and the feature point data of the input image in association with each other in the feature point data storage unit 106.

The feature point data storage unit 106 stores the feature point data generated by the feature point data generation unit 105 based on the input from the user. Although the feature point data storage unit 106 is included in the input assistance apparatus 100 in the configuration illustrated in FIG. 3, the feature point data storage unit 106 may be implemented in another apparatus communicably connected to the input assistance apparatus 100 via a network or the like. In addition, the feature point data storage unit 106 may be configured as a database.

The data stored in the feature point data storage unit 106 can be used for any purpose. That is, the purpose of the work in which the user designates the position of the feature point with respect to the input image is arbitrary and is not limited to a specific purpose. For example, the feature point data may be used for collation of a person using a face image. Specifically, the input assistance apparatus 100 may be used in order to be able to specify which of known persons the person to be specified corresponds to by collating the feature points of the face image of the person to be specified with the feature points of the respective face images of a plurality of known persons. In this case, the input assistance apparatus 100 may be used to register the feature points of the face image of the known person in the database in advance, or the input assistance apparatus 100 may be used to specify the feature points of the face image of the person to be compared with the feature points stored in the database. The use of the feature point data is not limited to the image collation. For example, feature point data may be collected to generate new data from the feature point data. Specifically, feature point data may be collected to generate data of a bounding box surrounding a predetermined portion (for example, eyes). In addition, feature point data may be collected in order to generate statistical data of positions of feature points. In addition, feature point data may be collected to be used as training data for creating a machine learning model. As described above, the purpose of the work in which the user designates the position of the feature point with respect to the input image is arbitrary.

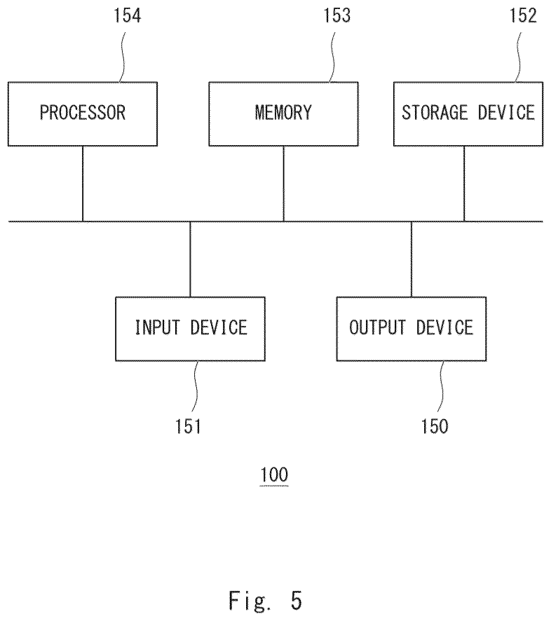

FIG. 5 is a block diagram illustrating an example of a hardware configuration of the input assistance apparatus 100. As illustrated in FIG. 5, the input assistance apparatus 100 includes an output device 150, an input device 151, a storage device 152, a memory 153, and a processor 154.

The output device 150 is an output device such as a display that outputs information to the outside. The display may be, for example, a flat panel display such as a liquid crystal display, a plasma display, or an organic electro-luminescence (EL) display. Further, the output device 150 may include a speaker. The output device 150 displays a user interface provided by the user interface unit 104.

The input device 151 is a device for the user to perform input via the user interface, and is, for example, an input device such as a pointing device or a keyboard. Examples of the pointing device include a mouse, a trackball, a touch panel, and a pen tablet. The input device 151 and the output device 150 may be integrally configured as a touch panel.

The storage device 152 is a non-volatile storage device such as a hard disk or a flash memory. The model storage unit 101 and the feature point data storage unit 106 described above are realized by, for example, the storage device 152, but may be realized by another storage device.

The memory 153 includes, for example, a combination of a volatile memory and a non-volatile memory. The memory 153 is used for storing software (a computer program) including one or more instructions to be executed by the processor 154, data used for various processes of the input assistance apparatus 100, and the like.

The processor 154 reads and executes software (computer program) from the memory 153, thereby performing the processing of the input image acquisition unit 102, the estimation unit 103, the user interface unit 104, and the feature point data generation unit 105 described above. The processor 154 may be, for example, a microprocessor, a micro processor unit (MPU), a central processing unit (CPU), or the like. The processor 154 may include a plurality of processors.

As described above, the input assistance apparatus 100 has a function as a computer.

The program includes a group of commands (or software codes) for causing a computer to perform one or more functions that have been described in the example embodiments when the program is read by the computer. The program may be stored in a non-transitory computer readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage devices. The program may be transmitted on a transitory computer-readable medium or a communication medium. By way of example, and not limitation, transitory computer-readable or communication media include electrical, optical, acoustic, or other forms of propagated signals.

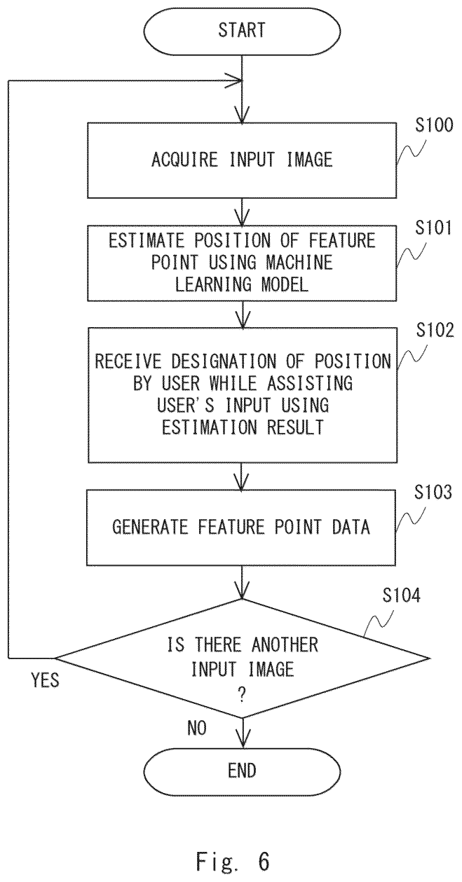

Next, an operation of the input assistance apparatus 100 will be described with reference to a flowchart. FIG. 6 is a flowchart illustrating an example of the operation of the input assistance apparatus 100. Hereinafter, the flow of the operation of the input assistance apparatus 100 will be described with reference to FIG. 6.

In step S100, the input image acquisition unit 102 acquires an image showing a predetermined target object (human face).

Next, in step S101, the estimation unit 103 estimates the positions of the feature points of the input image acquired in step S100 using the machine learning model stored in the model storage unit 101.

Next, in step S102, the user interface unit 104 provides a user interface that accepts, from the user, an input for designating the position of the feature point with respect to the input image acquired in step S100, and accepts the input from the user. At that time, the user interface unit 104 receives the designation of the position by the user while assisting the user's input using the estimation result obtained in step S101. Specifically, as described above, the user interface unit 104 displays the feature point at the estimated position on the input image. Further, the user interface unit 104 may output a warning in a case where a deviation between the position designated by the input by the user and the estimated position exceeds a threshold.

Next, in step S103, the feature point data generation unit 105 uses the position determined according to the user's input as the position of the feature point of the input image, and generates feature point data representing the feature point of the input image. Then, the feature point data generation unit 105 stores the generated feature point data in the feature point data storage unit 106.

Next, in step S104, the input image acquisition unit 102 determines whether there is a next input image. That is, the input image acquisition unit 102 determines whether there is another input image for which the position of the feature point should be designated. In a case where there is another input image, the process returns to step S100, and the above-described process is repeated. On the other hand, when there is no other input image, the process ends.

The first example embodiment has been described above. According to the input assistance apparatus 100, the estimation result of the machine learning model is used to assist the user's input. According to the input assistance apparatus 100, the user can easily designate an appropriate position as the position of the feature point of the image. In particular, in this example embodiment, the user interface unit 104 assists the user's input by displaying the position estimated by the estimation unit 103 prior to the user's input of the position of the feature point. According to such a configuration, it is possible to perform work while viewing the estimation result of the machine learning model learned using the training data created by a skilled person who is well aware of the reference of the position of the feature point. Therefore, even a less experienced user of input work for designating the position of the feature point can easily designate an appropriate position as the position of the feature point of the image. That is, even a beginner in the input work of designating the position of the feature point can designate the position of the feature point in the same manner as a skilled person who is familiar with the reference of the position of the feature point. In addition, since it is also possible to use only the work of correcting the estimated position as the user's work, it is possible to expect reduction of the work load and achievement of efficient work.

Further, as described above, the user interface unit 104 may output a warning on the basis of the magnitude of the deviation between the position designated by the user's input and the position estimated by the estimation unit 103. According to such a configuration, it is possible to prevent the user from erroneously designating an inappropriate position as the position of the feature point. That is, the occurrence of human error can be suppressed. In particular, according to such a configuration, since the position of the feature point is evaluated using the estimation result of the estimation unit 103 and the input result, an appropriate position in consideration of the estimation by the apparatus and the determination by the user can be set as the position of the feature point.

Further, as described above, the input image may be a face image, and the feature point may be a feature point of the face. With the use of the input assistance apparatus 100 for the input image and the feature point, the user can appropriately designate the position of the feature point even for the face that is the target object having the individual difference.

### First Modified Example of First Example Embodiment

Next, a first modified example of the first example embodiment will be described. In the above-described example embodiment, the user interface unit 104 displays the position estimated by the estimation unit 103 prior to the input by the user. However, the user interface unit 104 may not display the position estimated by the estimation unit 103 prior to the input by the user. In this case, the user interface unit 104 may assist the user's input by evaluating the user's input on the basis of the position designated by the user's input and the position estimated by the estimation unit 103. For example, the user interface unit 104 may evaluate the magnitude of the deviation between the position designated by the input by the user and the position estimated by the estimation unit 103, and output the evaluation result. Specifically, for example, in a case where the magnitude of the deviation is equal to or less than a predetermined threshold, the user interface unit 104 may perform output notifying that a position close to the position indicated by the estimation result of the model is designated as the evaluation result. Note that the predetermined threshold may be the same as the threshold described in the first example embodiment, that is, the threshold for outputting the warning based on the magnitude of the deviation. Further, in a case where the magnitude of the deviation exceeds a predetermined threshold, the user interface unit 104 may output a warning as the evaluation result. The user who has received the warning can designate an appropriate position as the position of the feature point by correcting the position of the feature point as necessary. The evaluation result may be displayed on the UI screen or may be output by voice. According to such a configuration, since the user can obtain a material for determining whether the position designated by the user is appropriate, the user can easily designate an appropriate position as the position of the feature point. In particular, according to this modified example, the display for assistance can be reduced as compared with the first example embodiment. Therefore, it is possible to prevent the user from being bothered by such display at the time of input.

### Second Modified Example of First Example Embodiment

Next, a second modified example of the first example embodiment will be described. In the above-described example embodiment, the estimation unit 103 estimates only the positions of the feature points. However, the estimation unit 103 may further estimate the order of the plurality of feature points of the input image. For example, in a case where it is necessary to generate feature point data representing position information in a predetermined order for each feature point, the order of these feature points is defined in advance. In this case, the user needs to designate the positions of the plurality of feature points of the target object according to a predetermined order. Describing using a specific example, for example, an order is defined in advance for nineteen feature points of the input image of the face, and the user may need to designate the position of each feature point according to this order. In this case, it is required to prevent designation of the positions of the feature points in an incorrect order.

Therefore, the estimation unit 103 may estimate the positions of the plurality of feature points of the input image together with the order of the feature points using the machine learning model. Then, the user interface unit 104 may assist designation of the positions of the feature points by the user according to the order. As a result, it is possible to suppress designation of the positions of the feature points in an incorrect order. Note that such a machine learning model is learned in advance by machine learning such as deep learning using, for example, a set of an image, an order of each feature point of the target object appearing in the image, and a position of each feature point as training data. That is, the estimation unit 103 performs estimation processing using a machine learning model that has learned the position of each feature point together with the order information of each feature point.

For example, the user interface unit 104 may assist the user's input by displaying the estimated position of each feature point and the order of each feature point on the input image. More specifically, prior to the input of the position of the feature point by the user, the user interface unit 104 may display the feature point at the position estimated by the estimation unit 103 and display information indicating the order of each feature point on the input image. Here, the information indicating the order of each feature point is, for example, a number indicating the order, but may be a mark such as an arrow indicating the order. According to such a configuration, the user can perform work while viewing the estimation result of the machine learning model. Therefore, even a less experienced user of input work for designating the positions of the feature points can designate the positions of the feature points in an appropriate order.

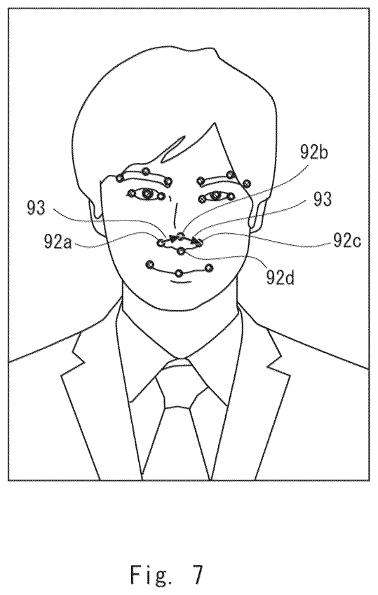

Further, the user interface unit 104 may assist the user's input by outputting a warning on the basis of a difference between the order estimated by the machine learning model and the order of designation of the positions of the feature points by the user. In this case, the user interface unit 104 outputs a warning in a case where the user designates the positions of the feature points in an order different from the estimated order. Specifically, for example, the user interface unit 104 outputs a warning for notifying that the user may be designating the positions of the feature points in an order different from the predetermined order. Note that this warning may be displayed on the UI screen or may be output by voice. FIG. 7 is a schematic diagram for explaining an input in an incorrect order. Here, as indicated by an arrow 93 illustrated in FIG. 7, the correct input order is input of the position of a feature point 92a indicating the left end of the nose, then input of the position of a feature point 92b indicating the vertex of the nose, and then input of the position of a feature point 92c indicating the right end of the nose. However, it is assumed that the user makes an input to plot the feature point 92a and then makes an input to plot a feature point 92d indicating the lower end of the nose. In this case, the user interface unit 104 outputs a warning. Note that, for example, in a case where the position of the feature point designated by the user is close to the estimated position of the feature point (feature point 92c) different from the feature point (feature point 92b) to be input next designated from the defined order, the user interface unit 104 determines that the input order is wrong. Here, the fact that the position of the feature point designated by the user is close to the estimated position means that a difference between the positions is equal to or less than a predetermined threshold. Note that the predetermined threshold may be the same as the threshold described in the first example embodiment, that is, the threshold for outputting the warning based on the magnitude of the deviation. In this way, by outputting a warning about the order error, it is possible to suppress generation of the feature point data in which the position information of each feature point is arranged in an order different from the predetermined order.

Although the second modified example of the first example embodiment has been described above, the second modified example described above may be combined with the first modified example described above.

### Second Example Embodiment

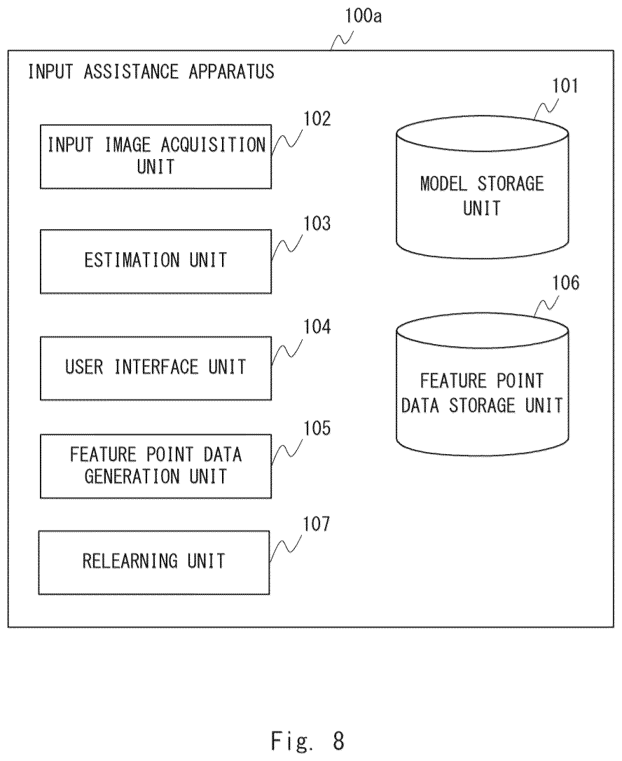

Next, a second example embodiment will be described. The second example embodiment is different from the first example embodiment in that a machine learning model is updated. FIG. 8 is a block diagram illustrating an example of a functional configuration of an input assistance apparatus 100a according to the second example embodiment. The input assistance apparatus 100a according to the second example embodiment is different from the input assistance apparatus 100 according to the first example embodiment in further including a relearning unit 107. The processing of the relearning unit 107 is also performed, for example, by the processor 154 reading and executing software (computer program) from the memory 153.

Hereinafter, differences from the first example embodiment will be specifically described, and redundant description will be omitted as appropriate. Note that the first modified example described above can be applied to the second example embodiment, and the second modified example described above can also be applied.

The relearning unit 107 performs the machine learning of the machine learning model again by using a combination of the input image acquired by the input image acquisition unit 102 and the position of the feature point designated by the input by the user for the input image as the training data. That is, the relearning unit 107 performs the machine learning of the machine learning model again by using the feature point data generated by the feature point data generation unit 105 as the training data.

The relearning unit 107 may use only the feature point data of some images generated by the user's instruction on the position of the feature point for relearning, or may use the feature point data of all the images for relearning. In particular, the relearning unit 107 may use, for relearning, the feature point data generated by the user's instruction to determine the designated position as the position of the feature point, contrary to the warning due to the magnitude of the deviation between the designated position of the user and the estimated position of the estimation unit 103 exceeding the threshold. Since such feature data is feature data for a peculiar image in which the estimation result of the model is wrong, it is possible to update the machine learning model to a model that performs appropriate prediction for such an image by performing relearning using such feature data. In addition, by using the feature point data for all the images for relearning, the machine learning model is learned by more training data, so that the stability of the machine learning model can be improved. Note that the relearning unit 107 may also perform relearning by using training data first used to generate the machine learning model.

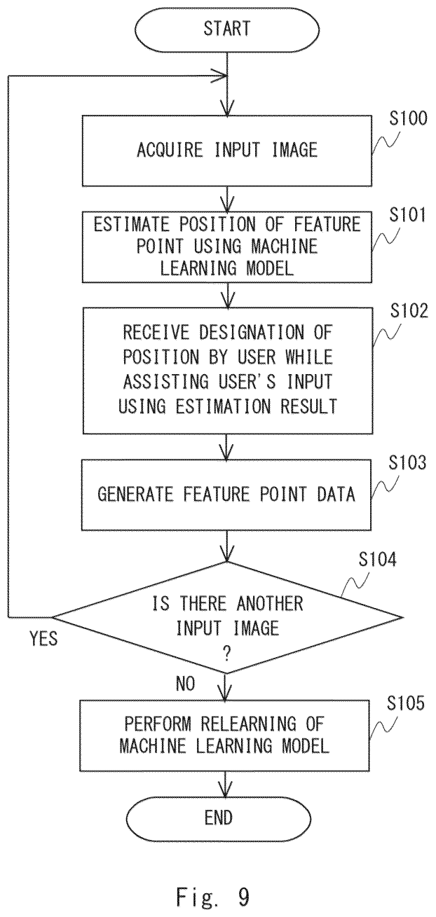

Next, an operation of the input assistance apparatus 100a according to the second example embodiment will be described with reference to a flowchart. FIG. 9 is a flowchart illustrating an example of the operation of the input assistance apparatus 100a according to the second example embodiment. As illustrated in FIG. 9, the flowchart shown here is different from the flowchart illustrated in FIG. 6 in that step S105 is added after step S104. Hereinafter, differences from the flowchart illustrated in FIG. 6 will be described.

In a case where it is determined in step S104 that there is no other input image, the process proceeds to step S105. In step S105, the relearning unit 107 reads, from the feature point data storage unit 106, the feature point data generated on the basis of the series of processes from step S100 to step S104, and performs relearning of the machine learning model stored in the model storage unit 101. Then, the relearning unit 107 stores the relearned machine learning model in the model storage unit 101. As a result, estimation is performed using the updated machine learning model in the next work.

The second example embodiment has been described above. According to the input assistance apparatus 100a, relearning of the machine learning model is performed. Therefore, the machine learning model is updated as needed, and the accuracy of the model can be improved. Therefore, the estimation of the estimation unit 103 can be performed more accurately.

Although the invention of the present application has been described above with reference to the example embodiments, the invention of the present application is not limited to the above. Various modified examples that can be understood by those skilled in the art can be made to the configuration and details of the invention of the present application within the scope of the invention. For example, various example embodiments and various modified examples can be appropriately combined.

Some or all of the above example embodiments may be described as the following Supplementary Notes, but are not limited to the following.

### (Supplementary Note 1)

An input assistance apparatus including:
an estimation means for estimating a position of a feature point of an input image; and
an input assistance means for assisting a user's input for designating a position of a feature point of the input image on a basis of a position estimated by the estimation means and a position designated by the input.

### (Supplementary Note 2)

The input assistance apparatus according to Supplementary Note 1, in which the input assistance means further assists the input by displaying an estimated position prior to the user's input.

### (Supplementary Note 3)

The input assistance apparatus according to Supplementary Note 1, in which the input assistance means does not display an estimated position prior to the user's input, and assists the input by evaluating the input on a basis of a position designated by the user's input and an estimated position.

### (Supplementary Note 4)

The input assistance apparatus according to any one of Supplementary Notes 1 to 3, in which the input assistance means assists by outputting a warning on a basis of a magnitude of a deviation between a position designated by the user's input and an estimated position.

### (Supplementary Note 5)

The input assistance apparatus according to any one of Supplementary Notes 1 to 4, in which
the estimation means estimates positions of a plurality of feature points of the input image together with an order of feature points, and
the input assistance means assists designation of positions of feature points by the user according to the order.

### (Supplementary Note 6)

The input assistance apparatus according to Supplementary Note 5, in which the input assistance means assists by displaying an estimated position of each feature point and an order of each feature point on the input image.

### (Supplementary Note 7)

The input assistance apparatus according to Supplementary Note 5 or 6, in which the input assistance means assists by outputting a warning on a basis of a difference between an estimated order and an order of designation of positions of feature points by the user.

### (Supplementary Note 8)

The input assistance apparatus according to any one of Supplementary Notes 1 to 7, in which
the estimation means estimates a position of a feature point of the input image using a machine learning model learned in advance, and
the input assistance apparatus further comprises a relearning means for performing machine learning of the machine learning model again by using a combination of the input image and a position designated by the user's input as training data.

### (Supplementary Note 9)

The input assistance apparatus according to any one of Supplementary Notes 1 to 8, in which the input image is a face image, and the feature point is a feature point of a face.

### (Supplementary Note 10)

An input assistance method including:
estimating a position of a feature point of an input image; and
assisting a user's input for designating a position of a feature point of the input image on a basis of an estimated position and a position designated by the input.

### (Supplementary Note 11)

A non-transitory computer readable medium storing a program for causing a computer to execute:
estimating a position of a feature point of an input image; and
assisting a user's input for designating a position of a feature point of the input image on a basis of a position estimated by the estimating and a position designated by the input.

### REFERENCE SIGNS LIST

1 INPUT ASSISTANCE APPARATUS
2 ESTIMATION UNIT
3 INPUT ASSISTANCE UNIT
100 INPUT ASSISTANCE APPARATUS
100a INPUT ASSISTANCE APPARATUS
101 MODEL STORAGE UNIT
102 INPUT IMAGE ACQUISITION UNIT
103 ESTIMATION UNIT
104 USER INTERFACE UNIT
105 FEATURE POINT DATA GENERATION UNIT
106 FEATURE POINT DATA STORAGE UNIT
107 RELEARNING UNIT
150 OUTPUT DEVICE
151 INPUT DEVICE
152 STORAGE DEVICE
153 MEMORY
154 PROCESSOR

What is claimed is:

1. An input assistance apparatus comprising:
at least one memory storing instructions; and
at least one processor configured to execute the instructions to:
estimate a position of a feature point of an input image; and
assist a user's input for designating a position of a feature point of the input image on a basis of an estimated position and a position designated by the input.

2. The input assistance apparatus according to claim 1, wherein the processor is further configured to execute the instructions to further assist the input by displaying an estimated position prior to the user's input.

3. The input assistance apparatus according to claim 1, wherein the processor is further configured to execute the instructions to not display an estimated position prior to the user's input, and assist the input by evaluating the input on a basis of a position designated by the user's input and an estimated position.

4. The input assistance apparatus according to claim 1, wherein the processor is further configured to execute the instructions to assist by outputting a warning on a basis of a magnitude of a deviation between a position designated by the user's input and an estimated position.

5. The input assistance apparatus according to claim 1, wherein the processor is further configured to execute the instructions to:
estimate positions of a plurality of feature points of the input image together with an order of feature points, and
assist designation of positions of feature points by the user according to the order.

6. The input assistance apparatus according to claim 5, wherein the processor is further configured to execute the instructions to assist by displaying an estimated position of each feature point and an order of each feature point on the input image.

7. The input assistance apparatus according to claim 5, wherein the processor is further configured to execute the instructions to assist by outputting a warning on a basis of a difference between an estimated order and an order of designation of positions of feature points by the user.

8. The input assistance apparatus according to claim 1, wherein the processor is further configured to execute the instructions to:
estimate a position of a feature point of the input image using a machine learning model learned in advance, and
perform machine learning of the machine learning model again by using a combination of the input image and a position designated by the user's input as training data.

9. The input assistance apparatus according to claim 1, wherein the input image is a face image, and the feature point is a feature point of a face.

10. An input assistance method comprising:
estimating a position of a feature point of an input image; and
assisting a user's input for designating a position of a feature point of the input image on a basis of an estimated position and a position designated by the input.

11. A non-transitory computer readable medium storing a program for causing a computer to execute:
estimating a position of a feature point of an input image; and
assisting a user's input for designating a position of a feature point of the input image on a basis of a position estimated by the estimating and a position designated by the input.
